(19) United States
(12) Patent Application Publication
(10) Pub. No.: US 2006/0136327 A1
(43) Pub. Date: Jun. 22, 2006

(54) Risk control system

(76) Inventor: Cheng Hwee You, Singapore (SG)

Correspondence Address: NIXON PEABODY, LLP, 401 9TH STREET, NW, SUITE 900, WASHINGTON, DC, 20004-2128, US

(21) Appl. No.: 10/550,617

(22) PCT Filed: Jul. 1, 2003
(86) PCT No.: PCT/SG03/00156

§ 371 Date: Sep. 26, 2005

(30) Foreign Application Priority Data
Apr. 1, 2003 (SG) 200301769-6

(51) Int. Cl. G06Q 40/00; G06F 17/30; G06F 12/00

(52) U.S. Cl. 705/38; 707/201

(57) ABSTRACT

The invention provides a method for assessing risk within an organization, comprising: defining one or more zones (2), each of the one or more zones comprising an environment; identifying one or more assets (4) of the organization, each of the assets being located in a respective one of the zones; conducting a respective impact assessment (6) for each of the assets, each assessment comprising assessing the impact of the loss of the respective asset; conducting for each of the zones a respective zone risk assessment (8a), comprising assessing the risk level associated with placing a respective asset within the respective corresponding zone; and conducting for each asset a respective asset risk assessment (8b), comprising assessing the risk level associated with the respective asset independent of the respective zone of the respective asset; and assessing risk on the basis of at least the impact assessment, the zone risk assessments and the asset risk assessments. The invention also provides a risk management method, comprising assessing risk according to the method described above and managing said risk.

### FIELD OF THE INVENTION

The present invention relates to a method and system for controlling risk, or particular but by no means exclusive application is quantitative risk assessment and mitigation.

### BACKGROUND OF THE INVENTION

There are essentially two approaches to risk analysis: qualitative and quantitative. Qualitative risk analysis is a technique that can be used to determine the level of protection required for applications, systems, facilities, or other enterprise assets. During the systematic review of assets, threats, and vulnerabilities, the team will be able to establish the probabilities of threats occurring, the cost of losses if they do occur, and the value of the safeguards or countermeasures designed to reduce the threats and vulnerabilities to an acceptable level. The qualitative methodology attempts only to prioritize the various risk elements in subjective terms.

Quantitative risk analysis attempts to assign independently objective numeric values to the components of the risk analysis and to the Level of potential losses. When all elements (asset value, threat frequency, safeguard effectiveness, safeguard costs, uncertainty and probability) are quantified, the process is considered to be quantitative.

The respective advantages and disadvantages of these two approaches may be summarized as follows:

Qualitative Risk Analysis Approach

| ADVANTAGES | DISADVANTAGES |
|---|---|
| calculations are simple | subjective in nature |
| monetary value of assets not | depends solely on quality of |
| required | risk management team |
| unnecessary to quantify | limited effort devoted to |
| threat frequency | assigning monetary value to |
| | targeted assets |
| non-security and non- | provides no basis for the |
| technical staff readily | cost-benefit analysis of |
| involved | risk mitigation |
| flexibility in processing | |
| and reporting | |

Quantitative Risk Analysis Approach

| ADVANTAGES | DISADVANTAGES |
|---|---|
| results are substantially | calculations can be complex |
| based on independently | |
| objective processes and | |
| metrics | |
| great effort put into asset | works well with a recognized |
| value determination and risk | automated tool and |
| mitigation | associated knowledge base |
| obliges the conducting of a | requires large amounts of |
| cost/benefit assessment | preliminary work |
| results can be expressed in | generally not presented on a |
| management-specific language | personal level |
| | participants cannot be |
| | easily coached through the |
| | process |

Most existing risk assessment models are qualitative; risks are measured based on perceived threat and not quantified through mathematical means. However, as perception of threat differs from assessor to assessor, risk assessment derived by qualitative means tends to be inconsistent, hence making the results unreliable and unusable.

The characteristics of various existing techniques are as follows.

1. 10-Step Qualitative Risk Analysis (QRA)

The ten steps of this approach are:

i. A Scope Statement is developed;

ii. A cross functional Competent Team is assembled to assess the risks;

iii. All threats (characterized in terms of agent, motive and results) are identified;

iv. Threats are prioritized (by a strong team);

v. Impact Priority is assessed;

vi. Total Threat Impact is calculated;

vii. Safeguards are identified;

viii. A Cost-Benefit Analysis is made of the controls against cost and effectiveness;

ix. Safeguards are ranked in order of priority; and

x. A Risk Analysis Report is prepared, including:

Thus, for example, a notional Risk Analysis Report might include the following:

| | THREAT | LOSS | RISK | | |
|---|---|---|---|---|---|
| | PRIORITY | IMPACT | FACTOR | POSSIBLE | SAFEGUARD |
| THREAT | (TP) | (LI) | (TP + LI) | SAFEGUARDS | COST |
| Fire | 3 | 5 | 8 | Fire suppression | $15,000 |
| | | | | system | |
| Tornado | 2 | 5 | 8 | Business | $75,000 |
| | | | | continuity plan | |
| Water | 2 | 3 | 7 | Business | $75,000 |
| damage | | | | continuity plan | |
| Theft | 3 | 5 | 5 | | |

This technique forms the basis of all existing risk assessment: a risk analysis team is formed, threats and their effects are discussed during the risk assessment and countermeasures are used to mitigate risks.

2. 3-Step Qualitative Risk Analysis (QRA)

The three steps of this approach are:

i. Asset Valuation;

ii. Risk Evaluation; and

iii. Risk Management

A notional result of the approach might include:

| FINANCIAL LOSS | VALUATION SCORE |
|---|---|
| <$2,000 | 1 |
| $2,000 to $15,000 | 2 |
| $15,000 to $40,000 | 3 |
| $40,000 to $100,000 | 4 |
| $100,000 to $300,000 | 5 |
| $300,000 to $1,000,000 | 6 |
| $1,000,000 to $3,000,000 | 7 |
| $3,000,000 to $10,000,000 | 8 |
| >$10,000,000 | 9 |

This is a slight modification of the first above mentioned approach, in which a scoring system is used whenever possible. A re-assessment interval of 1.5 to 2 years is recommended.

3. Information Security Risk Analysis (ISRA)

The three steps of this approach are:

i. A Risk Analysis Matrix is created (according to Integrity, Sensitivity and Availability);

ii. Risk Based Control is selected; and

iii. Preparation of documentation.

A notional Risk Analysis Matrix might be:

DATA

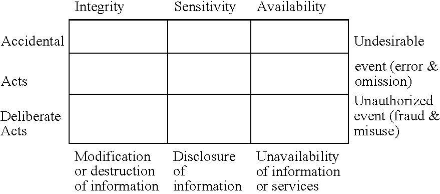

This approach is difficult to use, and requires users to have a certain expertise. In addition, the analysis is not asset or system based.

4. Vulnerability Analysis

The approach has five steps:

i. Internal experts or a risk analysis team are assembled;

ii. A scope statement is developed;

iii. Definitions are agreed upon;

iv. The team's understanding of the process is verified; and

v. The risk is calculated.

Thus, a possible assessment of risk associated with each human factor might be:

| Occu- | Unauthorized | Unauthorized | Unauthorized | De- |
|---|---|---|---|---|
| pation | Access | Modification | Disclosure | struction |
| VP of HR | | | | |
| Senior | | | | |
| managers | | | | |
| Senior | | | | |
| specialist | | | | |

This methodology analyzes the vulnerabilities of a department with respect to the people (treated as assets) who work in the assessment zone. However, the definitions must be agreed upon before the assessment can begin.

5. Hazard Impact Analysis

This approach is similar to approach 4, but based on asset categories rather than assets. It might produce, for example, the following output:

| | | | | Busi- | | |
|---|---|---|---|---|---|---|
| Threat | Proba- | Human | Property | ness | Internal | External |
| Type | bility | Impact | Impact | Impact | Resources | Resources |
| Tornado | 1 | 4 | 4 | 4 | 2 | 2 |
| 1 | 2 | 3A | 3B | 3C | 4A | 4B |

This approach identifies the threats and measures the impact on human, property and business. The existing internal and external controls are identified to mitigate the respective threats.

6. Threat Analysis

According to this approach, one:

i. Internal experts or a risk analysis team are assembled;

ii. A scope statement is developed;

iii. Definitions are agreed upon;

iv. The team's understanding of the process is verified; and

v. The risk analysis is conducted based on the impact on operations if a threat occurs.

For example, the following conclusions might be obtained:

| | Effects on Operations | | | | |
|---|---|---|---|---|---|
| | | | Hard- | Loss of | |
| Potential | Temporary | Temporary | ware | Soft- | Repairable |
| Causes | Interruption | Inaccessibility | Damage | ware | Damage |

| | | |
|---|---|---|
| LAN | P | M |
| server | | |
| outage | | |

This approach assesses the operational risk in a specified environment.

7. Questionnaire

According to this approach, a series of questions are compiled to measure compliance with an existing enterprise policy, procedure, standard, or other regulation.

8. Single Time Loss Algorithm

Single Time Loss (STL) is determined acording to this approach, where:
STL=(Total asset value+Contingency implementation costs+Data reconstruction costs)×Probability of Occurrence+(Cost of one week delay).

Single Time Loss is used as an impact value measurement.

9. Facilitated Risk Analysis Process (FRAP)

This approach includes:

i. Defining the scope of the review;

ii. Assembling representatives for the FRAP process;

iii. Defining threats against data integrity, confidentiality and availability;

iv. Creating a Priority Matrix based on degree of vulnerability and business impact;

The three deliverables include identification of risk, prioritization of risks, suggested controls for major risks. A list of 26 control grouping can be selected (e.g. backup, recovery plan, access control) and the approach allows project tracking and cross checking for verification purposes.

A possible Priority Matrix might be:

| Risk | | | | |
|---|---|---|---|---|
| No. | Risk | Type | Priority | Controls |
| 1 | Information accessed by | INT | B | 3, 5, 6, 11, |
| | unauthorized personnel | | | 12, 16 |
| 2 | Unclear or non-existent | INT | B | 9, 13, 26 |
| | versioning of the information | | | |
| 3 | Database corrupted by hardware | INT | D | |
| | failure, or incorrect or bad | | | |
| | software | | | |

This approach involves analyzing one system, application, or segment of business operation at one time. The possible effects of system failures, etc., are measured against threats and vulnerabilities. Controls are then identified to mitigate the threats.

10. Risk Assessment and Management

In this approach, threat impact is measured by Annualized Loss Expectancy of Exposure (ALE). ALE is measured based on Single Loss Expectancy (SLE) and Annualized Rate of Occurrence (ARO). SLE is defined as expected monetary loss for each occurrence of a threat event; ARO is defined as statistical rate of threat occurrence on a annual basis BIA is measured based on Single Loss Expectancy (SLE).

Statistical information of Annualized Rate of Occurrence (ARO) is obtained at least on a yearly basis.

11. Integrated Risk Management

This approach includes:

i. Separating Custodians and Users of Information;

ii. Defining the basic pre-requisite (e.g. roles and responsibility definition, data classification and inventory control); and

iii. Managing Risk in an integrated fashion.

In this approach, information security encompasses the use of physical and logical data access controls to ensure the proper use of data and to prohibit unauthorized or accidental modification, destruction, disclosure, loss, or access to automated assets. Risk Analysis identifies and assesses risks associated with corporate information assets and defines cost-effective approaches to managing such risks.

This approach introduces the concept of custodian and user of information. It demonstrates that through risk assessment, business continuity and information security controls shall be implemented. Business continuity is taken out as a module, separate from typical risk assessment. The potential impact of systems is measured against the total project cost, financial impact, customer impact, regulatory/compliance impact. Alternatively, this impact can be measured against information classification and longest tolerable outage.

Business Impact Loss is measured against time sensitivity (Longest tolerable outage period during peak), intangible loss (health and safety, customer satisfaction, embarrassment) and tangible loss (financial).

All existing risk assessment models, however, assume (whether explicitly or implicitly) that a competent cross-departmental team will be assembled to assess the risk. However, assessments are often actually performed by either by the IT technical support team or the business owner, hence resulting in incomplete understanding of the threats and available controls. When the responsibility for conducting the risk assessment become unclear, the results become unreliable.

Further, when the magnitude of the risk assessment increases, it is common for assessors to compromise the assessment process. This is particularly so when it the assessment is qualitatively based. This compromise may be due to human factors and time constraints.

### SUMMARY OF THE INVENTION

The present invention provides, therefore, in a first broad aspect, a method for assessing risk within an organization, comprising:

defining one or more zones, each of said one or more zones comprising an environment;

identifying one or more assets of said organization, each of said assets being located in a respective one of said zones;

conducting a respective impact assessment for each of said assets, each assessment comprising assessing the impact of the loss of said respective asset;

conducting for each of said zones a respective zone risk assessment, comprising assessing the risk level associated with placing a respective asset within said respective corresponding zone;

conducting for each asset a respective asset risk assessment, comprising assessing the risk level associated with said respective asset independent of the respective zone of said respective asset; and

assessing risk on the basis of at least said impact assessment, said zone risk assessments and said asset risk assessments.

Thus, an asset can be anything of value. The method can therefore be used to produce as an output a risk assessment. When the final steps are performed by computer, the computer can output this assessment.

Preferably the method includes identifying one or more asset custodians, each comprising a custodian of a respective asset, and identifying one or more asset owners, each comprising an owner of a respective one or more of said assets.

A custodian is typically some employee with care-taking responsibilities. In an IT environment, a custodian might be a Technical Management Team or a Project Management Team, an individual member of such teams; a custodian may be an employee who acts as a caretaker of an automated or manual file or database. An asset owner is typically (though not necessarily) the one who pays for the asset; it may in many cases be the owner of the business. Generally, however, it is the person with overall responsibility for defining the security policies and the security and system requirements of the asset, and who can approve the security control implementation plan on the asset. It may be an end-user.

Preferably the method includes maintaining a register of said assets. Preferably said register includes the respective owner of each of said assets.

Preferably the method includes maintaining a register of said zones. Preferably said register includes the respective custodian of each of said zones.

In one embodiment, each of said assets is information related, such as materials and equipment that are used for data manipulation or storage.

In this embodiment, each of said asset custodians is an information custodian, each comprising a custodian of a respective information storage device within said organization.

Preferably the method includes defining at least four types of custodians: 1) physical and environment custodians, 2) network custodians, 3) software engineering custodians, and 4) MIS support custodians.

Preferably each of said respective zone assessments is conducted by the respective custodian of said respective zone.

Preferably each of said respective asset assessments is conducted by the respective owner of said respective asset.

Preferably the method includes regarding the loss of an asset as equivalent to the loss of a system of which said asset is a part.

Preferably the method includes determining a measured risk for each asset, said measured risk for a respective asset comprising the product of 1) an impact level determined in said impact assessment and 2) the maximum of an asset risk determined in said asset risk assessment and an asset risk determined in said zone risk assessment.

In another broad aspect, the present invention provides a risk management method, comprising:

assessing risk according to the method described above; and

managing said risk.

Preferably said managing of said risk comprises:

determining the distribution of the number of assets as a function of associated measured risk;

determining a maximum acceptable risk level; and

applying one or more controls if any of said assets exceeds said maximum acceptable risk level.

Preferably the acceptable risk level comprises the lower of the highest available measured risk or 100%.

In another broad aspect, the invention provides an apparatus for assessing risk within an organization, comprising:

data input means for inputting asset information into a register of assets, each of said assets being an asset of said organization, each of said assets being located in a respective zone;

data storage for storing said register of assets, including for each of said assets said respective zone;

means for receiving or storing a respective zone risk assessment for each of said zones, said respective zone risk assessment comprising an assessment of the risk level associated with placing a respective asset within said respective corresponding zone;

means for receiving or storing a respective asset risk assessment for each asset, said respective asset risk assessment comprising an assessment of the risk level associated with said respective asset independent of the respective zone of said respective asset;

means for receiving or storing a respective impact assessment for each of said assets, each assessment comprising assessing the impact of the loss of said respective asset, and for assessing risk on the basis of at least said impact assessment, said zone risk assessments and said asset risk assessments to thereby form a risk assessment; and

output means for outputting said risk assessment.

Of course, the means for receiving or storing a respective zone risk assessment, the means for receiving or storing a respective asset risk assessment and the means for receiving or storing a respective impact assessment may be provided as a single integer (such as a data input or data storage means).

Typically these values will be prepared separately and input into the apparatus. However, optionally, the apparatus may include data processing means for forming the zone and asset risk assessments and the, again optionally, the impact assessment, for determining or for assisting in the determination of these factors. The factors would then be stored in the respective receiving or storing means.

Preferably the apparatus is operable to associate with each of said assets an asset custodian, each comprising a custodian of a respective asset, and to associate with each of said assets at least one asset owner, each comprising an owner of a respective one or more of said assets.

Preferably the register of assets includes a respective owner of each of said assets.

Preferably the apparatus includes data storage for storing a register of said zones.

Preferably the zone register includes data for associating a respective custodian with each of said zones.

Preferably each of said assets is information related.

Preferably each of said respective zone assessments is conducted by the respective custodian of said respective zone, and preferably each of the respective asset assessments may be conducted by the respective owner of the respective asset.

Preferably the apparatus is operable to treat the loss of an asset as equivalent to the loss of a system of which said asset is a part.

Preferably the apparatus is operable to determine a measured risk for each asset, said measured risk for a respective asset comprising the product of 1) an impact level determined in said impact assessment and 2) the maximum of an asset risk determined in said asset risk assessment and an asset risk determined in said zone risk assessment.

The invention also provides computer readable media with software portions executable on a computer for performing the above mentioned methods.

### BRIEF DESCRIPTION OF THE DRAWINGS

In order that the present invention may be more clearly ascertained, a preferred embodiment will now be described, by way of example, with reference to the drawings, in which:

FIG. 1 is a flow chart illustrating the six main stages of the risk assessment method according to a preferred embodiment of the present invention;

FIG. 2 is a schematic depiction of the relationship between different types of zones according to the method of FIG. 1;

FIG. 3 is a schematic depiction of a plot of Number of Assets (N_{A}) with a particular Measured Risk Level (MRL) against Measured Risk Level according to the method of FIG. 1;

FIG. 4A is a view similar to that of FIG. 3, additionally showing today's “Safety Line”;

FIG. 4B is a view similar to that of FIG. 4A, indicating the possible deterioration of the distribution of FIG. 4A after a pre-defined period;

FIG. 4C is an alternative view to that of FIG. 4B, indicating the possible evolution of the distribution after a pre-defined period provided that risk mitigation measures have been taken;

FIG. 5 is thus a flow chart of the steps for the addition of a new system according to the method of FIG. 1;

FIG. 6 is a flow chart of the steps for the upgrading of an existing system according to the method of FIG. 1;

FIG. 7 is a flow chart of the steps for the removal of a system or an asset according to the method of FIG. 1;

FIG. 8 is thus a flow chart of the steps for the upgrading of an existing Zone according to the method of FIG. 1;

FIG. 9 is a flow chart of the steps for the removal of a Zone according to the method of FIG. 1;

FIG. 10 is a flow chart of the steps for the addition of new threats and controls according to the method of FIG. 1;

FIG. 11 is a flow chart of the steps taken after a major version freeze according to the method of FIG. 1; and

FIG. 12 is a schematic view of a database design for use in implementing the method of FIG. 1.

### DETAILED DESCRIPTION OF THE PREFERRED EMBODIMENTS

A risk assessment method for assessing an organization's risks, according to a preferred embodiment of the present invention, will now be described in detail.

The method includes establishing four criteria: 1) Asset/Information Classification, 2) Asset Inventory, 3) Roles and Responsibilities, and 4) Custodian and User Identification.

The following assumptions are used:
Threats are specific and are associated with asset types;
Likelihood (of a threat) can be based on demographical statistics; and
Risk management is a multi-decision process.

According to this embodiment, an “asset” is defined as anything that has value to the organization and is information related, including materials and equipment that are used for data manipulation or storage.

The broad classifications of assets include 1) People, 2) Software, 3) Services, 4) Media, 5) Physical, 6) Information and 7) Operating Systems. Each asset classification is further categorized into respective asset types; the method includes registering all assets under one of the asset types, which include:

1) People: contractors, internal staff or employees;

2) Software: customized application software, developed software, audit software, Off-the-shelf applications;

3) Services: third party facilities;

4) Media: paper documents, computer media;

5) Physical: cryptographic facility, mobile devices, network devices, office equipment, servers, workstations, hardware management equipment, physical audit tools;

6) Information: business information, configuration information, financial information, personal information; and

7) Operating Systems: O/S Non-Windows, O/S Windows.

Thus, for example, the information classification refers to the different grading of information sensitivity in accordance to the company practices and culture. The method includes classifying all information under one of the information classification categories.

All assets are registered with proper ownership. The asset owner is defined as one who pays for the asset. The Asset register is updated whenever there is any addition, modification and deletion to an asset.

The method is preferably conducted by a cross functional team consisting of executive management, information security team, technical management team, project management team, business owners and auditors.

The responsibilities of executive management are: 1) to set management intent and business objectives with respect to information security, 2) to set impact loss monetary scale, 3) to confirm the degree of assurance required for risk mitigation, 4) to review and approve risk assessment and management reports, 5) to review and approve risk reduction measures, 6) to review and approve exception reports, and 7) to review control implementation progress.

The responsibilities of the Information Security Team are: 1) to review and agree on threat frequency, 2) to develop a baseline for information classification as corporate governance, 3) to maintain threats and controls database, 4) to review risk assessment and management reports, 5) to review risk reduction measures, and 6) to review control implementation progress.

The responsibilities of the Technical Management Team are: 1) to register the team assets into the Asset Register, 2) to perform risk assessment on respective areas of responsibilities, 3) to review and propose effective countermeasures, and 4) to follow-up on control implementation progress.

The responsibilities of the Project Management Team are: 1) to register the team assets into the Asset Register, 2) to perform risk assessment on respective areas of responsibilities, 3) to review and propose effective countermeasures, and 4) to follow-up on control implementation progress.

The responsibilities of the Business Owners are: 1) to register the assets into the Asset Register, 2) to perform risk assessment on individual asset, 3) to review and propose effective countermeasures, and 4) to follow-up on control implementation progress.

The responsibilities of the Auditors are: 1) to review risk assessment and management reports, 2) to review exception reports, and 3) to review for irregular risk distribution patterns.

Each of these parties participate in the risk assessment according to the organization's Information Security Management System (ISMS). Each party thus has its roles and responsibilities properly defined.

According to the method, information custodians and owners, respectively, are identified. Based on the defined roles and responsibilities, custodians typically include the Technical Management Team and the Project Management Team; the owners include the business owners.

A custodian is thus typically an employee that acts as a caretaker of an automated or manual file or database. The method defines four types of custodians, namely: 1) physical and environment custodian, 2) network custodian, 3) software engineering custodian, and 4) MIS support custodian.

Physical and environment custodians are those who take care of the physical well-being of the environmental zone. These generally refer to office administrators and physical security administrators.

Network custodians are those taking care of the organization network zones. These generally refer to LAN and WAN administrators and network security administrators.

Software Engineering custodians are those who develop and maintain software applications for the organization. These generally refer to software project managers and project team leads.

MIS Support custodians are those who maintain the operations for the proper running of the systems. These generally refer to system administrators, database administrators and data center managers.

The owner of the information is an individual that has specified limited authority granted by the owner of the information to view, change, add, disseminate or delete such information. These include business owners. Note that custodians may also own assets. In such a case, they may also be business owners.

The method proceeds as a six stage process where custodians and owners are segregated from the beginning. Broadly speaking, the custodians perform zone assessments and the owners perform asset assessments. Independent assessments are collated and results are generated based on the assessments.

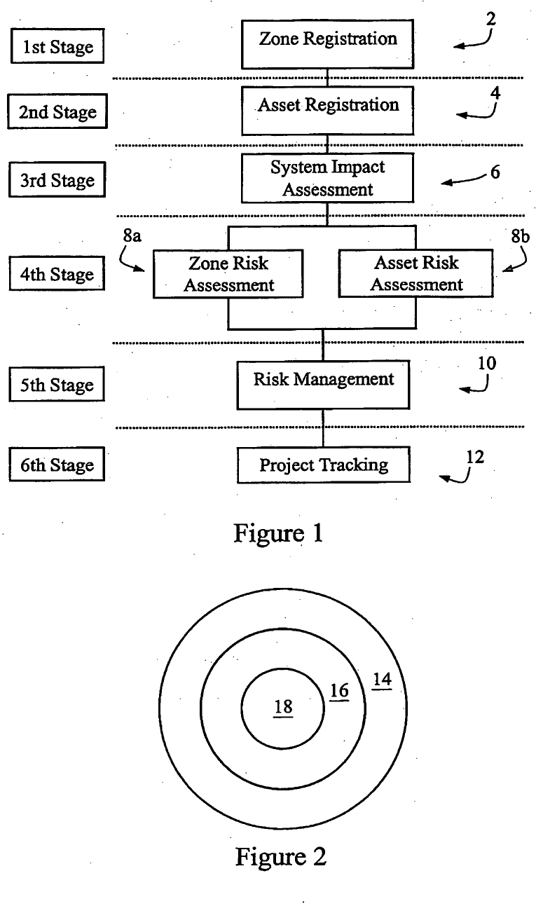

Referring to FIG. 1, the six stages may be summarized as follows.

| Stage | Summary |
|---|---|
| 1st | Zone Registration (2): all zones within the |
| | organization - whether real or virtual - are |
| | categorized and identified. |
| 2nd | Asset Registration (4): all assets are categorized |
| | and inventoried. |
| 3rd | System Impact Assessment (6): systems are measured |
| | based on total loss of confidentiality, integrity |
| | and availability. |
| 4th | Zone Risk Assessment (8a): zones are measured |
| | against a set of security best practices. |
| | Asset Risk Assessment (8b): individual asset risk |
| | level is measured against a set of security best |
| | practices. The measured risk of each individual |
| | asset is the product of the impact level and the |
| | asset risk level. |
| 5th | Risk Management (10): assets that are overexposed |
| | and require some form of risk mitigation are |
| | identified. Assessors select controls for risk |
| | mitigation and these selected controls are tracked |
| | accordingly. |
| 6th | Project Tracking (12): all security |
| | implementations are tracked. |

First Stage: Zone Registration (2)

Theoretically, assessors should be able to assess the risk based on the existing controls, but evidence has shown that—owing to factors such as job specialization and responsibilities, and cross departmental relationships—assessors are usually faced with the daunting task of assessing risk associated with matters of which they have no prior knowledge or familiarity. This is primarily because risk assessment is a multi-user decision process.

Studies have also demonstrated that different parties should be involved in securing any information asset. It is a common practice that one party determines the environment, while the asset owner places their information asset into the environment.

The present method employs a Zone concept to address this problem. A Zone is defined as an environment built to contain assets. According to the method, all relevant Zones within the organization are registered.

The method recognizes four Zones, namely: 1) Physical and environment Zone, 2) Network Zone, 3) Software Engineering Zone, and 4) MIS Support Zone. These, it will be noted, correspond to the custodians described above.

A Physical and environment Zone is an environment that is used to protect physically the assets placed therewithin. The custodians of this Zone are typically office administrators or physical security administrators.

A Network Zone is an environment that is used to restrict access to the network to protect the accessibility of that asset. The custodians of this Zone are typically WAN administrators and network security administrators.

A Software engineering Zone is an environment that is used to develop and maintain software for the organization. The custodians of this Zone are typically software project managers and project team leaders.

An MIS Support Zone is an environment that is used to maintain the system to ensure the operability of the systems. The custodians of this Zone are typically system administrators, database administrators and data center managers.

As most zone protection is designed to be layered, the method employs zone inheritance. Referring to FIG. 2, this means that controls implemented in a perimeter zone (14) are inherited by a more inner zone (16) and similarly also inherited by an innermost trusted zone (18). According to the method, zone inheritance is practised in the Physical and environment Zone and in the Network Zone.

Second Stage: Asset Registration (4)

In the Asset Registration stage (4), assets are collated for risk assessment and management. The method mimics the real-world system modeling where services and system concepts are introduced in this phase, and thereby enhance the effectiveness and efficiency in asset management and maintenance.

In this stage, according to the method a “service” is defined to be a combination of systems that is required to fulfill a business delivery, while a “system” is defined to be a combination of components (defined as “assets”) to realize a function. By means of this modeling, all assets (including non-IT based assets) are registered. Complex relationships between services, system and components can thus be expressively captured.

The way these definitions interact can be seen from the following simple examples. A Business-to-business (B2B) service (i.e. the “service”) may consist of a web server (a “system”), an application server (a further “system”) and a database server (a further “system”). The web server consists of CPU hardware (an “asset” of classification “physical”, type “hardware”), an operating system (an “asset” of classification “software”), web hosting software (an “asset” of classification “software”), information web pages (an “asset” of classification “information”) and B2B functional specification document (an “asset” of classification “media”).

Alternatively, a networking service (a “service”) may consist of a firewall system (a “system”) and a networking system (a further “system”). The Networking system may consist of a network switch (an “asset” of classification “physical”), network routers (“assets” also of classification “physical”), router firmware (an “asset” of classification “software”) and a routing configuration (an “asset” of classification “information”).

As a further example, a departmental service (a “service”) may consist of several departmental teams (each a “system”). Each team may comprise various appointments (each an “asset” of classification “people”). In another example, a facilities service (a “service”) may consist of an electrical system (a “system”) and an air conditioning system (a further “system”). An electrical system may comprise an uninterruptable power supply (an “asset” of classification “hardware”) and electrical power (an “asset” of classification “service”).

When systems are registered, relevant zones are also specified. This facilitates subsequent zone assessment. For example, a web server will ultimately be described as in a Physical Zone and a Network Zone, maintained by an operational and development team.

However, assets that provide physical and network countermeasures will not be registered as having physical and network zones respectively.

According to the method, when assets are registered, they are specified according to their asset type.

If the asset type is an information classification, it needs to be further defined according to the information sensitivity classification. A system inherits the sensitivity of the highest sensitivity information stored within the system, and propagates to the rest of the assets that are non-information based. In terms of the previous example of a web server, if the sensitivity marking of the information is confidential, then the rest of the system including the CPU hardware and web hosting software will inherit the confidential marking.

Third Stage: System Impact Assessment (6)

Impact assessment is a process of measuring the total impact in the event of a total single asset loss, independent of other losses. As defined earlier, according to the method it is assumed that any component failure would lead to a total failure of the system. Hence, the method conducts the impact assessment at the system level. However, a failure in the system may not render the entire service to fail.

The method—during this stage—takes into consideration five criteria: 1) Loss of Opportunity, 2) Loss of Productivity, 3) Loss due to Regulatory Breaches, 4) Cost of System Investment, and 5) Information Classification Rating.

Further, in the course of impact assessment, the method always assumes the worst case scenario.

The Loss of Opportunity refers to the loss of monetary gain during the period of system unavailability as well as the potential future loss.

The Loss of Productivity is the loss of efficiency of the users and the cost of recovery within the organization during the period of system unavailability.

The Loss due to Regulatory Breaches is the cost of contractual or/and legislation payout due to breaches in service level agreement or law.

The Cost Of System Investment is the cost of rebuilding an identical system.

Information Classification Rating refers to the highest aggregate information classification stored in the system.

Loss of Opportunity, Loss of Productivity, Loss due to Regulatory Breaches and Cost of System Investment are calculated as monetary indices. An example of such a monetary index is as follows:

| Monetary value x | Monetary index |
|---|---|
| x < $10,000 | 1 |
| $10,000 ≦ x < $20,000 | 2 |
| $20,000 ≦ x < $40,000 | 3 |
| $40,000 ≦ x < $80,000 | 4 |
| $80,000 ≦ x < $160,000 | 5 |
| $160,000 ≦ x < $320,000 | 6 |
| $320,000 ≦ x < $640,000 | 7 |
| $640,000 ≦ x < $1,280,000 | 8 |
| $1,280,000 ≦ x < $2,560,000 | 9 |
| x ≧ $2,560,000 | 10 |

The monetary scale will differ from one organization to another. The highest monetary index value is assigned to the total valuation loss of the ISMS scope. Each scale increment is the multiple of two of the previous, starting from a figure defined by the organization.

Each criterion is weighted according to the organization objectives and goals, while the summation of the weights should add up to 100%. This reflects the relative importance of the five criteria. The weights are defined by the management based on business focus and management intent.

Each system is assessed based on these criteria, and the total impact valuation is computed using the formula:

$$Total Impact = \frac{100 \% \times Σ ( criterion {value}_{i} \times criterion {weight}_{i} )}{Σ ( max criterion {value}_{i} \times max criterion {weight}_{i} )}$$

Assets under the system inherit the impact valuation of the system.

The following table defines the criteria that are considered in rating system impact that associated with different components of the organization. This is to ensure consistency among those who input the system impact weighting.

| CRITERION | IT SYSTEMS | NON-IT SYSTEMS | PEOPLE |
|---|---|---|---|
| Loss of | Amount due to | Loss due to 7 | Loss due to |
| Productivity | users' 7 day | day productivity | inability to |
| | productivity | loss; | perform work for |
| | loss; | Cost of system | 7 days; |
| | Cost of system | recovery. | Amount incurred |
| | recovery. | | due to idle |
| | | | people. |
| Loss of | Income loss for | Income loss for 7 days; | |
| Opportunity | 7 days; | Potential future business loss; | |
| | Potential | Cost of damage control. | |
| | future business | | |
| | loss for Y | | |
| | years; | | |
| | Cost of damage | | |
| | control. | | |
| Cost of | Development | Hardware cost; | Hiring |
| System | cost; | Software cost. | cost; |
| Investment | Hardware cost; | | Training |
| | Software cost; | | cost. |
| | Information | | |
| | cost. | | |

| | |
|---|---|
| Loss due to | Amount compensated due to failure to meet |
| Regulatory | regulatory requirements; |
| Breaches | Amount due to legal implication. |

Y is determined by management; it depends on the service or product of the organization

Fourth Stage: Zone Assessment (8a)

In the Zone Assessment Stage (8a), the first of the two parts of the Fourth Stage, an operating environment is evaluated based on the number of security controls implemented. The object of the assessment is to assess the risk level when an asset is placed within the environment. As mentioned above, the four Zone categories are Physical and environmental, Network, Software Engineering and MIS Support. The related threats are linked automatically based on the nature of the zone category; this greatly reduces the assessor's overhead in having to individually review the suitability of each threat in relation to the zone.

Each threat is associated with a likelihood of threat occurrence, based on the criteria of demographic statistics, nature of business activities and organization culture. Likelihood is assigned a percentage probability:

| Likelihood of Occurrence | Percentage |
|---|---|
| Not Applicable | 0% |
| Rarely | 20% |
| Unlikely | 40% |
| Possible | 60% |
| Highly Possible | 80% |
| Definitely | 100% |

Each threat is associated with a list of security measures that can be adopted to manage risk. These measures are further weighted in order to differentiate between the strengths of different security controls. Generally, the effectiveness of a control is computed according to this method as follows:

| Control Type | Control Effectiveness |
|---|---|
| Guidelines, Work Instruction | 20% |
| Policy and Standards | 40% |
| Procedure and Forms | 50% |
| Technical Implementation | 60%-100% |

The degree of risk associated with each Zone is determined on the basis of the number of security solutions implemented against the threat. More than one threat may

$$ZRL = MAX ( 1 - \frac{Σ ( {SI}_{i} \times {SW}_{i} )}{Σ ( {SW}_{i} )} \times LO ) \times 100 \%$$

be associated to a zone, so the method includes assuming that the weakest security link is the threat having the highest risk exposure. Thus:
where:

ZRL=Zone Risk Level,

SI=Solution Implementation,

SW=Solution Weight, and

LO=Likelihood of Occurrence

According to the asset sensitivity marking, baseline controls are reflected as mandatory, so assessors are able to differentiate between mandatory and optional controls, resulting in clearer objective in reducing risks.

For the sake of efficiency, the method includes allowing assessors to apply a particular zone assessment to the relevant zone that possess identical controls, thereby streamlining the effort required by the assessor.

Fourth Stage: Asset Risk Assessment (8b)

According to the method, in the Asset Risk Assessment Stage (8b) an asset is evaluated based on the number of security controls implemented. The objective of the assessment is to assess the risk level of an asset, independent of the zones. As each asset has an associated asset type and asset type has its related threats, each asset is automatically link to its associated threats; this reduces the assessor's overhead in having to individually review the suitability of each threat in relation to the asset.

As above, each threat is associated with a likelihood of threat occurrence, based on the criteria of demographic statistics, nature of business activities and organization culture and expressed as a probability.

As in Zone Risk Assessment (see above), each threat in Asset Risk Assessment has a list of security measures that can be adopted to manage risk. These measures are further weighted so as to differentiate the strengths of different security controls. The effectiveness of a control is computed as discussed above.

Based on the number of security solutions implemented against the threat, the degree of risk associated with each asset is measured in a manner comparable to that described above under “Zone Risk Assessment”. Hence, Asset Risk Level is determined as follows:

$$ARL = MAX ( 1 - \frac{Σ ( {SI}_{i} \times {SW}_{i} )}{Σ ( {SW}_{i} )} \times LO ) \times 100 \%$$

where:

ARL=Asset Risk Level,

SI=Solution Implementation,

SW=Solution Weight, and

LO=Likelihood of Occurrence

According to the asset sensitivity marking, baseline controls are reflected as mandatory, so assessors are able to differentiate between mandatory and optional controls, resulting in clearer objectives in reducing risks.

In order to improve on the efficiency, the method also allows assessors to apply a particular asset assessment to relevant asset that possess identical controls.

Each asset is assessed based on the total impact and the risk level using the formula:
Measured Risk=Total Impact×MAX(ARL, ZRL)
Fifth Stage: Risk Management (10)

To date, there are no fixed approaches to risk management and many organizations depend heavily on Management to provide some indication of how risk should be managed. However, Management may not know how to improve their organization's Information Security Management System or ISMS, and in fact require guidance in making a decision as to how to manage risk. Furthermore, no prior art risk management model possesses a continual improvement feature.

The method includes the six sigma concept for risk management processes. However, it should be noted that the method only employs certain parts of the six sigma concept and is somewhat modified. By using this approach, the method can be used to assist the organization in identifying the potential high risk assets that require immediate attention, hence maintaining the security effectiveness of the organization over time.

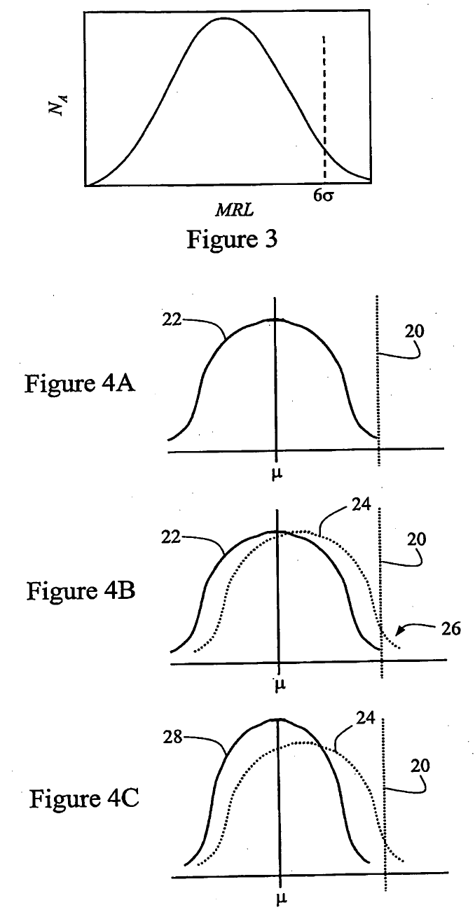

Thus, according to the method, all assets are tabulated against their Measured Risk Level. The Number of Assets (N_{A}) with any particular Measured Risk Level (MRL) is plotted against Measured Risk Level; this is shown schematically in FIG. 3. It will be appreciated that it may be necessary to group ranges of values of N_{A} in suitably sized bins. The measured Risk distribution will be a bell shaped curve as it is two-dimensional (i.e. Impact Level, Asset/Zone Risk Level).

FIG. 4A is another schematic representation of N_{A} versus MRL. Vertical line (20) is the today's “Safety Line”, which marks the highest available Measured Risk or 100%, whichever is lower. The method includes assuming that assets available today are sufficiently protected.

Owing to technological and other advancements, some assets may become exposed owing to control insufficiency and ineffectiveness. Referring to FIG. 4B, assets will tend to increase in MRL until the original distribution (22) shifts right (i.e. towards higher values of MRL) to new distribution (24). Hence, assets that are near or at today's Safety Line (20) may no longer be safe after a pre-defined period and then be on the high side (26) of today's Safety Line (20).

Thus, assets that are near or at today's Safety Line (20), because they may not be safe after a defined period, should be reviewed. More controls should be applied accordingly so that the risk exposure is addressed currently and for the defined period, so that instead of the distribution becoming new distribution (24) of FIG. 4B, it becomes, say, a modified distribution (28) as shown in FIG. 4C. The modified distribution (28) may differ from the original distribution (22), but it has the desired property that all assets are adequately protected.

Hence, based on standard Six Sigma concept calculations of a 1.5σ shift to the right, the threshold marks the recommended degree of assurance. Assets that are above the degree of assurance are highlighted for risk mitigation. A range of controls, zone or/and asset based, for mitigation purposes are made available for implementation scheduling.

According to the method, it is recognized that the following parameters may change over time: 1) Effectiveness of Controls, 2) Threat Frequency, 3) New Controls, and 4) New Threats.

Effectiveness of Controls may change owing to human intelligence advances.

Threat Frequency may change owing to changes in political or social stability in one or more particular areas.

New Controls may change owing to new advancement of technology or methods of risk mitigation.

New Threats may change owing to the introduction of new technology that affects the current information security of the organization.

Hence, continual risk assessment is conducted—according to the present method—at least on a yearly basis to maintain the effectiveness of the ISMS.

Sixth Stage: Project Tracking (12)

Risk assessment does not stop at selecting controls for risk mitigation, but rather only after controls have been implemented. Hence, each control scheduled for implementation during the risk management phase is tracked.

It should be noted that the present method treats planned controls as unimplemented controls. Only completed and verified controls are regarded as implemented controls.

During this stage, information (such as the person responsible for control implementation, the implementation method, the cost and effort of implementation, estimated and actual implementation start and end date) is captured.

Event Flow

The method of this embodiment is event driven, and an effect on the knowledge base or the asset registry will result in a change in result computed according to the method.

The method will have an impact (that is, performs a role) under the following conditions:
1) Addition of a new System;
2) Upgrade of an existing System
3) Removal of a System or an Asset;
4) Addition of a new Zone;
5) Upgrade of an existing Zone;
6) Removal of a Zone;
7) Addition to the database of New Threats and Controls; and
8) Versioning.
   1. Addition of a New System

New Systems are proposed as part of a new project to be added to the environment.

Such new Systems are incorporated into the present method for risk assessment in two phases: pre-tender system planning and post-tender system planning.

During the pre-tender system planning, the owner-to-be is unlikely to know what the detailed assets will be. Hence, risk assessment is done at the system level by means of a questionnaire. Based on the questionnaire, the related threats and mandatory controls corresponding to the system's information class is then displayed for the owner-to-be.

Once the system configuration is fixed, the pre-tender system planning information is converted into post tender system planning information. The system is marked as non-production so that the computation will be kept separate from actual systems within the environment. Users verify the assessment input again to ensure data validity.

This is done to ensure that new systems can be planned properly and ensuring that the system security readiness is adequate when launched.

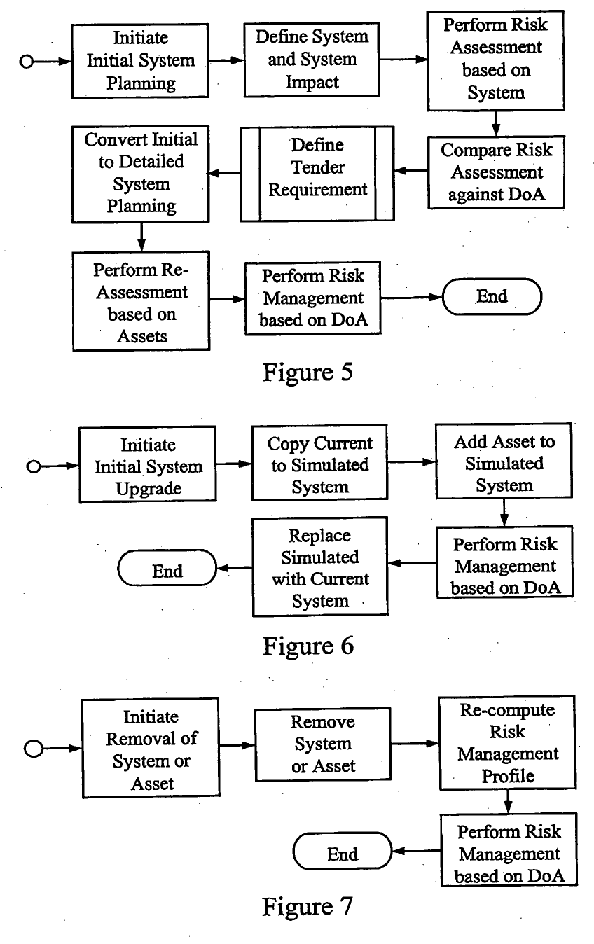

FIG. 5 is thus a flow chart of the steps—according to the present method—for the addition of a new system.

2. Upgrade of an Existing System

When existing systems are being re-used as part of a new service launch, new assets are usually added to an existing system.

All existing systems being considered by the present method will be affected. The relevant existing system is replicated accordingly and treated as a planned system so that it does not corrupt the existing system configuration. The replicated system is linked to the additional assets for risk assessment. Once the evaluation has been completed, the replicated system replaces the existing system in the database.

There is no planned assets feature because of the potential complexity and integrity of the input; thus, the risk of data corruption is minimized.

FIG. 6 is a flow chart of the steps, according to the present method, for the upgrading of an existing system.

3. Removal of a System or an Asset

An existing system or asset may be removed owing to obsolescence or to wear and tear.

No system or asset other than the removed system or asset is affected. However, the overall risk management statistics may change owing to the removal. Thus, as each asset contributes to the overall risk management results, a review of the risk management result and further risk reduction may be required.

FIG. 7 is a flow chart of the steps—according to the present method—for the removal of a system or an asset.

4. Addition of a Zone

A new Zone may be proposed as part of the new environment. There is no effect on any asset until an asset is assigned to the new Zone, as a Zone is an environment and as long as the environment does not contain any asset, there are no risks involved.

5. Upgrade of an Existing Zone

However, if an existing Zone is upgraded (owing possibly to renovation or insufficiency of existing controls), systems that are within the upgraded Zone will be affected. This is because systems that are within the upgraded Zone automatically inherit the controls implemented within the Zone.

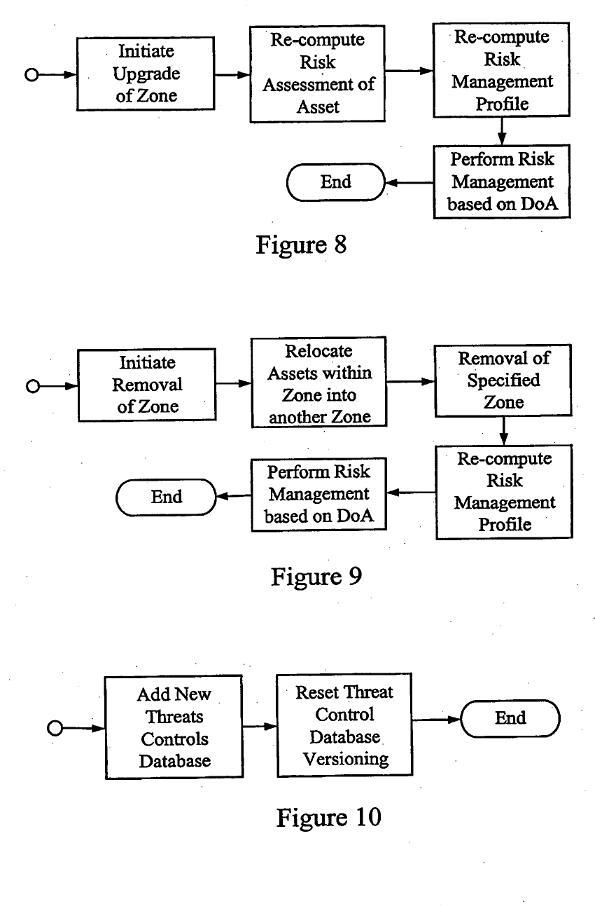

FIG. 8 is thus a flow chart of the steps—according to the present method—for the upgrading of an existing Zone.

6. Removal of a Zone

An existing Zone may be removed owing to, for example, a location shift. Systems that are within the Zone will be affected, as such systems will no longer have an environment to operate in. Hence, the method includes relocating such systems to another Zone for subsequent operations.

Thus, FIG. 9 is a flow chart of the steps—according to the present method—for the removal of a Zone.

7. Addition of New Threats and Controls

When new threats and controls are added to an organization's database (maintained for the purpose of implementing the method of this embodiment), only new assets registered subsequently will be affected.

Any implications on existing assets will only be evaluated, according to the present method, after a major version freeze initiated by the administrator, as it is impractical to have assessors re-evaluate the assets under new threats and controls each time there is an update. It is more practical for the re-assessment to take place every version cut, which is recommended to be at least once a year. The new assets are affected because they have been newly added and, according to security best practice, it is important to assess the system using the most recent available threats and solutions.

FIG. 10 is a flow chart of the steps—according to the present method—for the addition of new threats and controls.

8. Effects After a Major Version Freeze

An Administrator may initiate a major version freeze to the risk assessment database (such as on a yearly basis). All existing assets are reevaluated in the light of the most current threats and controls. The new risk management threshold is then recalculated.

The present method is a continual assessment methodology as threats and controls changes over time. It is thus critical to ensure that assessors perform risk assessment on a regular basis on the existing assets.

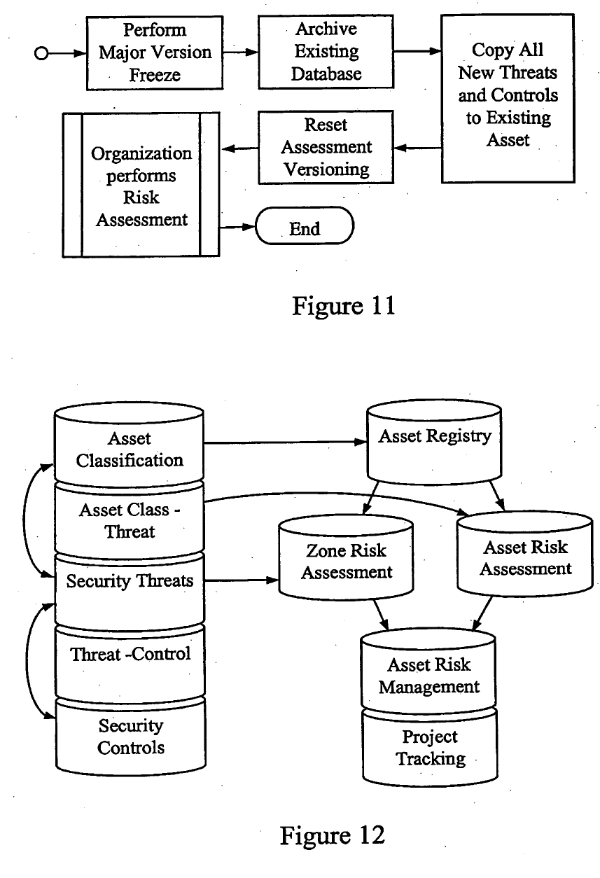

FIG. 11 is a flow chart of the steps—according to the present method—taken after a major version freeze.

Implementation Details

The present method is designed to be consistent with BS7799/ISO17799 ISMS. Using BS7799 control reference numbers, the method splits the controls into two categories, infrastructure and specific.

Infrastructure controls are fundamental controls required for setting up an ISMS. The following controls are considered as fundamental.

| BS7799 | |
|---|---|
| Control | |
| Reference No. | Control Description |
| 4.1.1.1 | Information security policy document |
| 4.1.1.2 | Policy Review and evaluation |
| 4.2.1.1 | Management information security forum |
| 4.2.1.2 | Information security co-ordination |
| 4.2.1.3 | Allocation of information security |
| | responsibilities |
| 4.2.1.4 | Authorization process for information |
| | processing facilities |
| 4.2.1.5 | Specialist information security advice |
| 4.2.1.6 | Co-operation between organizations |
| 4.2.1.7 | Independent review of information security |
| 4.2.2.1 | Identification or risk from third party |
| 4.2.2.2 | Security requirements in third party |
| | contracts |
| 4.3.1.1 | Inventory of asset |
| 4.3.2.1 | Classification guidelines |
| 4.3.2.2 | Information labelling and handling |
| 4.4.1.1 | Including security in job responsibilities |
| 4.4.3.1 | Reporting security incidents |
| 4.4.3.2 | Reporting security weaknesses |
| 4.4.3.4 | Learning from incidents |
| 4.4.3.5 | Disciplinary process |
| 4.6.1.3 | Incident management procedures |
| 4.6.6.3 | Information handling procedures |
| 4.9.1.1 | Business continuity management process |
| 4.10.1.1 | Identification of applicable legislation |
| 4.10.1.2 | Intellectual property rights (IPR) |
| | Procedures |
| 4.10.1.3 | Safeguarding of organizational records |
| | Framework |
| 4.10.1.4 | Data protection and privacy of personal |
| | information Controls |
| 4.10.1.5 | Prevention of misuse of information |
| | processing facilities |
| 4.10.1.6 | Regulation of cryptographic controls |
| 4.10.1.7 | Collection of evidence |
| 4.10.2.1 | Compliance with security policy |
| 4.10.3.1 | System audit controls |

Specific controls are controls that are selectable as part of the risk assessment management process. Specific controls are then divided into zone controls and asset controls.

A Zone control is defined as a <Security Control> applied to a <zone> to protect an <asset type>.

| BS7799 | |
|---|---|
| Control | |
| Reference No. | Control Description |
| 4.2.3.2 | Security compliance of oursourced service |
| | provider |
| 4.2.3.3 | Evaluation of outpowered service provider |
| 4.4.1.5 | Identification of sensitive position |
| 4.4.1.6 | Verification of computing facilities use |
| 4.4.2.2 | Training for job competency |
| 4.4.2.3 | Personnel safety training |
| 4.4.3.3 | Reporting software malfunctions |
| 4.4.4.1 | Responding to bomb and fire threats |
| 4.5.1.1 | Physical security perimeter |
| 4.5.1.2 | Physical entry controls |
| 4.5.1.3 | Securing offices, rooms and facilities |
| 4.5.1.4 | Working in secure areas |
| 4.5.1.5 | Isolated delivery and loading areas |
| 4.5.2.1 | Equipment siting and protection |
| 4.5.2.2 | Power supplies |
| 4.5.2.3 | Cabling security |
| 4.5.2.6 | Secure disposal or re-use of equipment |
| 4.5.3.1 | Clear desk and clear screen policy |
| 4.5.3.2 | Removal of property |
| 4.6.1.1 | Documented operating procedures |
| 4.6.1.2 | Operational change control |
| 4.6.1.4 | Segregation of duties |
| 4.6.2.1 | Capacity planning |
| 4.6.3.1 | Controls against malicious software |
| 4.6.4.2 | Operator logs |
| 4.6.4.3 | Fault logging |
| 4.6.5.1 | Network controls |
| 4.6.6.1 | Management of removable computer media |
| 4.6.6.2 | Disposal of media |
| 4.6.6.5 | Verification of Media |
| 4.6.7.2 | Security of media in transit |
| 4.6.7.3 | Electronic Commerce Security |
| 4.6.7.4 | Security of electronic mail |
| 4.6.7.5 | Security of electronic office systems |
| 4.6.7.7 | Other forms of information exchange |
| 4.7.1.1 | Access control policy |
| 4.7.1.2 | Access control based on segregation of |
| | duties |
| 4.7.3.1 | Password use |
| 4.7.4.1 | Policy on use of network services |
| 4.7.4.2 | Enforced path |
| 4.7.4.3 | User authentication for external |
| | connections |
| 4.7.4.4 | Node authentication |
| 4.7.4.5 | Remote diagnostic port protection |
| 4.7.4.6 | Segregation in networks |
| 4.7.4.7 | Network connection control |
| 4.7.4.8 | Network routing control |
| 4.7.4.9 | Security of network services |
| 4.7.5.1 | Automatic terminal identification |
| 4.7.5.2 | Terminal log-on procedures |
| 4.7.5.5 | Use of system utilities |
| 4.7.6.1 | Information access restriction |
| 4.7.7.1 | Event logging |
| 4.7.7.2 | Monitoring system use |
| 4.7.7.3 | Clock synchronization |
| 4.8.1.1 | Security requirements analysis and |
| | specification |
| 4.8.3.1 | Policy on the use of cryptographic controls |
| 4.8.4.1 | Control of operational software |
| 4.8.5.1 | Change control procedures |
| 4.8.5.2 | Technical review of operating system |
| | changes |
| 4.8.5.3 | Restrictions on changes to software |
| | packages |
| 4.8.5.4 | Covert channels and Trojan code |
| 4.10.2.2 | Technical compliance checking |

Each asset control is defined as a <Security Control> applied to the <asset type>.

| BS7799 | |
|---|---|
| Control | |
| Reference No. | Control Description |
| 4.2.3.1 | Security requirements in outsourcing |
| | contracts |
| 4.2.3.2 | Security compliance of outsourced service |
| | provider |
| 4.2.3.3 | Evaluation of outsourced service provider |
| 4.4.1.2 | Personnel screening and policy |
| 4.4.1.3 | Confidentiality agreements |
| 4.4.1.4 | Terms and conditions of employment |
| 4.4.1.5 | Identification of sensitive position |
| 4.4.1.6 | Verification of computing facilities use |
| 4.4.2.1 | Information security education and |
| | training |
| 4.4.2.2 | Training for job competency |
| 4.4.2.3 | Personnel safety training |
| 4.5.2.4 | Equipment maintenance |
| 4.5.2.5 | Security of equipment off-premises |
| 4.6.1.5 | Separation of development and operational |
| | facilities |
| 4.6.1.6 | External facilities management |
| 4.6.1.7 | Review of operational system |
| 4.6.2.2 | System acceptance |
| 4.6.4.1 | Information back-up |
| 4.6.6.1 | Management of removable computer media |
| 4.6.6.2 | Disposal of media |
| 4.6.6.4 | Security of system documentation |
| 4.6.7.1 | Information and software exchange |
| | agreements |
| 4.6.7.2 | Security of media in transit |
| 4.6.7.3 | Electronic commerce security |
| 4.6.7.6 | Publicly available systems |
| 4.7.2.1 | User registration |
| 4.7.2.2 | Privilege management |
| 4.7.2.3 | User password management |
| 4.7.2.4 | Review of user access rights |
| 4.7.3.1 | Password use |
| 4.7.3.2 | Unattended user equipment |
| 4.7.5.1 | Automatic terminal identification |
| 4.7.5.3 | User identification and authentication |
| 4.7.5.4 | Password management system |
| 4.7.5.6 | Duress alarm to safeguard users |
| 4.7.5.7 | Terminal time-out |
| 4.7.5.8 | Limitation of connection time |
| 4.7.5.9 | Control of input/output device |
| 4.7.6.2 | Sensitive system isolation |
| 4.7.8.1 | Mobile computing |
| 4.7.8.2 | Teleworking |
| 4.8.1.2 | Periodic review of security requirements |
| 4.8.2.1 | Input data validation |
| 4.8.2.2 | Control of internal processing |
| 4.8.2.3 | Message authentication |
| 4.8.2.4 | Output data validation |
| 4.8.3.2 | Encryption |
| 4.8.3.3 | Digital signatures |
| 4.8.3.4 | Non-repudiation services |
| 4.8.3.5 | Key management |
| 4.8.4.2 | Protection of system test data |
| 4.8.4.3 | Access control to program source library |
| 4.8.5.5 | Outsourced software development |
| 4.8.5.6 | Software maintenance |
| 4.8.5.7 | Assurance in software development |
| 4.10.2.2 | Technical compliance testing |
| 4.10.3.2 | Protection of system audit tools |

To employ the present method, a computer system with associated database (which may be distributed) is employed; the database has two parts: security knowledge base and operation information. The security knowledge base contains the dataset for the supply of threats and controls to the registered information assets. The operation information refers to the registered assets and the related information that concerns the security of the assets.

The security knowledge base contains information about the asset classification types, the zone threats, asset threats and security controls. The security knowledge base also contains the linkage between asset classification types and threats and the linkage between threats and security controls.

The operation information contains information about the asset registry, its impact assessment, the zone threats and its related implemented controls, the asset threats and its related implemented controls, the risk management controls and the implementation schedule.

The database design is shown schematically in FIG. 12: the security knowledge base is stored in the databases on the left in this figure, operation information in the databases on the right.

As the present method employs continual assessment, its effectiveness relies on the security knowledge base update. On a regular basis, both new and modified threats and the related controls are updated to the security knowledge base, which in turn updates the operation information.

The data in this database is highly sensitive, so it is important that the organization have full ownership as well as access control and transmission security. Access control helps to ensure user accountability, and also restricts information access, according to a user's access rights. Transmission security helps to prevent eavesdropping of sensitive information.

Access Control

Access control is used to prevent accidental modification of information and unauthorized user from viewing sensitive information.

Workgroups are created with a set of privileges dictating the use of system resources. Each user is assigned with a workgroup. Within the workgroup, users trust each other and have full control over each other's information. No information can be shard between workgroups.

Transmission Security

Secure Socket Layer (SSL) is used to secure transmissions in information exchange between one or more browsers and a central server used to implement the method.

Glossary

| TERM | DESCRIPTION |
|---|---|
| Infrastructure | Controls that forms the foundation for |
| Controls | building and maintaining the ISMS. |
| Zone | An asset custodian who has the |
| | responsibility to set up and maintain the |
| | environment, or provide the service for |
| | the asset. |
| Service | A service is viewed as a business |
| | delivery to either an internal or |
| | external customer. |
| | Provided by one or more systems. |
| System | A system is viewed as a data processing |
| | machine (information processing) or as a |
| | functional responsibility (people). |
| | Put together by one or more assets |
| | including hardware, software and |
| | information. |
| | Usually performs more than one task/ |
| | responsibility. |
| Asset | Anything that is essential for the |
| | formation and working condition of a |
| | system. |
| | It has value to an organization. |
| | It performs a specific task/ |
| | responsibility. |
| | An asset is grouped into seven broad |
| | asset classifications - Information, |
| | People, Software, Service, Media, |
| | Physical and Operating Systems. |
| Zone Owner | Oversees the day-to-day operations and |
| | maintenance of the zone and is |
| | accountable for the service provided by |
| | the zone. |
| | Has overall responsibility for defining |
| | the security policies, recommending, |
| | implementing security controls to ensure |
| | that the zone is suitably protected from |
| | security threats. |
| | May approve the security control |
| | implementation plan. |
| Zone Manager | The person is the superior of the zone |
| | owner. |
| | Is at least of managerial level. |
| | Approves the security policies and |
| | security control plans (including |
| | budget). |
| Asset Owner | Has overall responsibility for defining |
| | the security policies and the security |
| | and system requirements of the asset. |
| | Can approve the security control |
| | implementation plan on the asset. |
| | May be the end-user. |
| Asset Manager | The superior of the asset owner. |
| | Of at least managerial level. |
| | Approves the security policies and |
| | security control plans (including |
| | budget). |
| MIS Support | The team taking care of the day-to-day |
| Zone | operations, maintenance and enhancement |
| | of the information processing |
| | facilities. |
| | Includes the MIS support for system, |
| | database, and operation. |
| Network Zone | The network environment to restrict |
| | accessibility from or to a system. |
| Physical & | The physical and environmental setup that |
| Environmental | is available for housing an asset. |
| Zone | |
| Software | The software development team that |
| Engineering | primes the development. |
| Zone | They manage the project and use their |
| | software development methodologies. |
| Function | The functional team that the zone owner |
| | belongs to. |
| | May be a subset of a department. |
| | Has the same functional area of |
| | responsibilities in a service. |
| Workgroup | Provides a service for the assets. |
| | May comprise one Function but usually |
| | comprises several. |
| Impact | Impact assessment is a measure of impact |
| Assessment | a system has on a service in the event |
| | of system failure. |
| | It is measured in two dimensions: 1) |
| | viewed from a management standpoint |
| | (Management Intent), and 2) viewed from |
| | a system standpoint (Impact Value) |
| | Impact is calculated based on per |
| | incident/loss/compromise. |
| Management | Comprises a set of impact criteria: Loss |
| Intent | of Productivity, Loss of Opportunity, |
| | Loss Due to Regulatory Breach, Cost of |
| | System Investment, and Information |
| | Classification. |
| | A percentage is assigned by management |
| | to each criterion based on its relative |
| | importance to the organization. |
| Impact Value | Comprises the same set of impact |
| | criteria as management intent, except |
| | ‘Information Classification’. |
| | Indicates the financial loss to each |
| | impact criterion in an event of loss of |
| | confidentiality, integrity or system |
| | availability. |
| Threat | Has the potential to cause an unwanted |
| | incident by exploiting vulnerability. |
| | May result in harm to an asset. |
| | Usually has the following: a catalyst |
| | (or tool) to facilitate the |
| | exploitation, a motivation for the |
| | exploitation and an outcome due to the |
| | exploitation. |
| Likelihood | The probability of the threat happening, |
| | determined from national/international |
| | values/statistics (so may vary from |
| | location to location). |
| | Determined without any controls |
| | consideration. |
| | Since likelihood direct affects risk |
| | level, the likelihood for each threat is |
| | established by management before risk |
| | assessment is performed. |

### CONCLUSION

The method of performing risk assessment described above is thus a quantitative risk assessment approach. The compliance or advantages of this method are as follows:

| QUANTITATIVE | |
|---|---|
| ADVANTAGE | PRESENT METHOD COMPLIANCE |
| Results are substantially | All components are based on |
| based on independently | mathematical computation. |
| objective processes and | |
| metrics. | |
| Great effort put into | Employs rich knowledge |
| asset value determination | database for risk mitigation |
| and risk mitigation. | and includes a mechanism for |
| | valuing asset impact. |
| Includes a cost/benefit | Provides a range of measures |
| assessment. | for users to select to |
| | mitigate risk. |
| Results can be expressed | Can produce reports based on |
| in management-specific | statistical computation of |
| language. | degree of control |
| | implementation. |
| QUANTITATIVE | |
| DISADVANTAGE | PRESENT METHOD ADVANTAGE |
| Calculations can be | Mathematical computations can |
| complex. | be performed behind the |
| | scene, so users can |
| | concentrate on risk |
| | assessment. |
| To works well must be used | Comprises an automated tool |
| with a recognized | with associated knowledge |
| automated tool and | base. |
| associated knowledge base. | |
| Requires large amounts of | Provides a range of solution |
| preparatory work. | for the users to select to |
| | mitigate the risk. |
| Generally not presented on | Divides the assessment into |
| a personal level. | custodians and owners; each |
| | is presented on a personal |
| | level. |
| Participants cannot be | Should allow ready training |
| easily coached through the | of participants in risk |
| process. | assessment. |

Modifications within the scope of the invention may be readily effected by those skilled in the art. It is to be understood, therefore, that this invention is not limited to the particular embodiments described by way of example hereinabove.

1. A method for assessing risk within an organization, comprising:
defining one or more zones, each of said one and more zones comprising an environment;
identifying one or more assets of said organization, each of said assets being located in a respective one of said zones;
conducting a respective impact assessment for each of said assers, each assessment comprising assessing the impact of the loss of said respective asset;
conducting for each of said zones a respective zone risk assessment, comprising assessing the risk level associated with placing a respective asset within said respective corresponding zone;
conducting for each asset a respective asset risk assessment, comprising assessing the risk level associated with said respective asset independent of the respective zone of saud respective asset; and
assessing risk on the basis of at least said impact assessment, said zone risk assessment and said asset risk assessments.

2. A method as claimed in claim 1, including identifying one or more asset custodians, each comprising a custodian of a respective asset, and identifying one or more of said assets. pcm 3. A method as claimed in claim 2, wherein each of said custodians is an employee with care-taking responsibilities.

4. A method as claimed in claim 1, including maintaining a register of said assets. cm 5. A method as claimed in claim 4, wherein said register includes a respective owner of each of said assets.

6. A method as claimed in claim 1, including maintaining a register of said zones.

7. A method as claimed in claim 6, wherein said register includes a respective custodian of each of said zones.

8. A method as claimed in claim 1, wherein each of said assets is information related.

9. A method as claimed in claim 2, wherein each of said assets is information related, and each of said asset custodians is an information custodian, each comprising a custodian of a respective information storage device within said organization.

10. A method as claimed in claim 9, including defining at least four types of custodians: 1) physical and environment custodians, 2) network custodians, 3) software engineering custodians, and 4) MIS support custodians.

11. A method as claimed in claim 2, wherein each of said respective zone assessments is conducted by the respective custodian of said respective zone.

12. A method as claimed in claim 2, wherein each of said respective asset assessments is conducted by the respective owner of said respective asset.

13. A method as claimed in claim 1, including regarding the loss of an asset as equivalent to the loss of a system of which said asset is a part.

14. A method as claimed in claim 1, including determining a measured risk for each asset, said measured risk for a respective asset comprising the product of 1) an impact level determined in said impact assessment and 2) the maximum of an asset risk determined in said asset risk assessment and an asset risk determined in said zone risk assessment.

15. A method as claimed in claim 2, wherein none of said custodians is an owner.

16. An apparatus for assessing risk within an organization, comprising:
data input means for inputting asset information into a register of assets, each of said assets being an asset of said organization, each of said assets being located in a respective zone;
data storage for storing said register of assets, including for each of said assets said respective zone;
means for receiving or storing a respective zone risk assessment for each of said zones, said respective zone risk assessment comprising an assessment of the risk level associated with placing a respective asset within said respective corresponding zone;
means for receiving or storing a respective asset risk assessment for each asset, said respective asset risk assessment comprising an assessment of the risk level associated with said respective asset independent of the respective zone of said respective asset;
means for receiving or storing a respective impact assessment for each of said assets, each assessment comprising assessing the impact of the loss of said respective asset, and for assessing risk on the basis of at least said impact assessment, said zone risk assessments and said asset risk assessments to thereby form a risk assessment; and
output means for outputting said risk assessment.

17. An apparatus as claimed in claim 16, wherein said apparatus is operable to associate with each of said assets an asset custodian, each comprising a custodian of a respective asset, and to associate with each of said assets at least one asset owner, each comprising an owner of a respective one or more of said assets.

18. An apparatus as claimed in claim 16, wherein said register of assets includes a respective owner of each of said assets.

19. An apparatus as claimed in claim 16, wherein said apparatus includes data storage for storing a register of said zones.

20. An apparatus as claimed in claim 19, wherein said zone register includes data for associating a respective custodian with each of said zones.

21. An apparatus as claimed in claim 16, wherein each of said assets is information related.

22. An apparatus as claimed in claim 16, wherein said apparatus is operable to treat the loss of an asset as equivalent to the loss of a system of which said asset is a part.

23. An apparatus as claimed in claim 16, wherein said apparatus is operable to determine a measured risk for each asset, said measured risk for a respective asset comprising the product of 1) an impact level determined in said impact assessment and 2) the maximum of an asset risk determined in said asset risk assessment and an asset risk determined in said zone risk assessment.

24. A risk management method, comprising:
assessing risk according to the method of claim 1; and
managing said risk.

25. A method as claimed in claim 24, wherein said managing of said risk comprises:
determining the distribution of the number of assets as a function of associated measured risk;
determining a maximum acceptable risk level; and
applying one or more controls if any of said assets exceeds said maximum acceptable risk level.

26. A method as claimed in claim 24, wherein said acceptable risk level comprises the lower of the highest available measured risk or 100%.
